(19) United States
(12) Patent Application Publication
(10) Pub. No.: US 2021/0300155 A1
(43) Pub. Date: Sep. 30, 2021

(54) VEHICLE AIR CONDITIONING APPARATUS

(71) Applicant: SANDEN HOLDINGS CORPORATION, Isesaki-shi, Gunma (JP)

(72) Inventor: Yasuaki KANOU, Isesaki-shi, Gunma (JP)

(73) Assignee: Sanden Holdings Corporation, Isesaki-shi, Gunma (JP)

(21) Appl. No.: 17/261,827

(22) PCT Filed: Jun. 20, 2019
(86) PCT No.: PCT/JP2019/024448

§ 371 Date: Jan. 20, 2021

(30) Foreign Application Priority Data
Jul. 31, 2018 (JP) 2018-144336

(51) Int. Cl. B60H 1/32; B60H 1/00

(52) U.S. Cl. CPC B60H 1/3227; B60H 1/00878

(57) ABSTRACT

There is provided a vehicle air conditioning apparatus being capable of cooling, heating, and dehumidifying the vehicle compartment. A communication path is formed to allow communication between part of the first ventilation flue downstream of the heat absorbing unit in an air flow direction and part of the second ventilation flue upstream of the heat releasing unit in the air flow direction. The communication path is opened and closed by a communication path opening and closing damper. By this means, it is possible to perform the dehumidifying operation by opening the communication path without need of devices such as a dedicated outdoor heat exchanger, and a solenoid valve and a four-way valve to switch the refrigerant flow path in the refrigerant circuit.

### TECHNICAL FIELD

The present invention relates to a vehicle air conditioning apparatus capable of adjusting the humidity in the vehicle compartment of a vehicle.

### BACKGROUND ART

Conventionally, there has been known a vehicle air conditioning apparatus which includes a refrigerant circuit including a heat releasing unit configured to release heat from a refrigerant and a heat absorbing unit configured to absorb heat into the refrigerant; and a unit body including a first ventilation flue in which the heat absorbing unit is disposed, and a second ventilation flue in which the heat releasing unit is disposed. This vehicle air conditioning apparatus can perform: cooling operation to perform a heat exchange between the air flowing into the first ventilation flue and the refrigerant in the heat absorbing unit and supply the air into the vehicle compartment, and to perform a heat exchange between the air flowing into the second ventilation flue and the refrigerant in the heat releasing unit and discharge the air out of the vehicle compartment; and heating operation to perform a heat exchange between the air flowing into the first ventilation flue and the refrigerant in the heat absorbing unit and discharge the air out of the vehicle compartment, and to perform a heat exchange between the air flowing into the second ventilation flue and the refrigerant in the heat releasing unit and supply the air into the vehicle compartment (see, for example, Patent Literature 1).

The above-described vehicle air conditioning apparatus switches between the cooling operation and the heating operation by setting the destination of the air flowing out of each of the first ventilation flue and the second ventilation flue of the unit body to one of the inside and the outside of the vehicle compartment.

### CITATION LIST

### Patent Literature

PTL 1: Japanese Patent Application Laid-Open No. 2017-7627

### SUMMARY OF INVENTION

### Technical Problem

However, the above-described vehicle air conditioning apparatus discharges the air subjected to the heat exchange with the refrigerant in the heat absorbing unit to the outside of the vehicle compartment during the heating operation, and discharges the air subjected to the heat exchange with the refrigerant in the heat releasing unit to the outside of the vehicle compartment during the cooling operation. Therefore, the vehicle air conditioning apparatus cannot perform dehumidifying operation to heat the air in the heat releasing unit after cooling the air in the heat absorbing unit to reduce the moisture content of the air, and then supply the air into the vehicle compartment.

It is therefore an object of the invention to provide a vehicle air conditioning apparatus capable of cooling, heating and dehumidifying of the vehicle compartment without using a refrigerant circuit with a complex configuration.

### Solution to Problem

To achieve the object, the vehicle air conditioning apparatus according to the invention includes a refrigerant circuit including a heat releasing unit configured to release heat from a refrigerant and a heat absorbing unit configured to absorb heat into the refrigerant, and a unit body including a first ventilation flue in which the heat absorbing unit is disposed, and a second ventilation flue in which the heat releasing unit is disposed. The vehicle air conditioning apparatus can perform cooling operation to perform a heat exchange between air flowing into the first ventilation flue and the refrigerant in the heat absorbing unit and supply the air into a vehicle compartment, and to perform a heat exchange between air flowing into the second ventilation flue and the refrigerant in the heat releasing unit and discharge the air out of the vehicle compartment, and heating operation to perform a heat exchange between the air flowing into the first ventilation flue and the refrigerant in the heat absorbing unit and discharge the air out of the vehicle compartment, and to perform a heat exchange between the air flowing into the second ventilation flue and the refrigerant in the heat releasing unit and supply the air into the vehicle compartment. The unit body includes a communication path configured to allow communication between part of the first ventilation flue downstream of the heat absorbing unit in an air flow direction and part of the second ventilation flue upstream of the heat releasing unit in the air flow direction. The communication path is opened and closed by a communication path opening and closing damper.

By this means, the communication path is opened, and therefore the air having been flowing through the first ventilation flue and been cooled in the heat absorbing unit to reduce its moisture content flows into the second ventilation flue via the communication path and is heated in the heat releasing unit, and then is supplied into the vehicle compartment. Consequently, it is possible to dehumidify the vehicle compartment.

### Advantageous Effect

According to the invention, it is possible to perform the dehumidifying operation by opening the communication path without need of devices such as a dedicated outdoor heat exchanger, a solenoid valve and a four-way valve to switch the refrigerant flow path in the refrigerant circuit. Consequently, it is possible to reduce the manufacturing cost and improve the comfort of the vehicle compartment.

### BRIEF DESCRIPTION OF DRAWINGS

FIG. 1 schematically illustrates the configuration of an air conditioning unit configured to perform cooling operation according to an embodiment of the invention;

FIG. 2 schematically illustrates the configuration of the air conditioning unit configured to perform heating operation;

FIG. 3 schematically illustrates the configuration of the air conditioning unit configured to perform cooling and dehumidifying operation; and

FIG. 4 schematically illustrates the configuration of the air conditioning unit configured to perform heating and dehumidifying operation.

### DESCRIPTION OF EMBODIMENTS

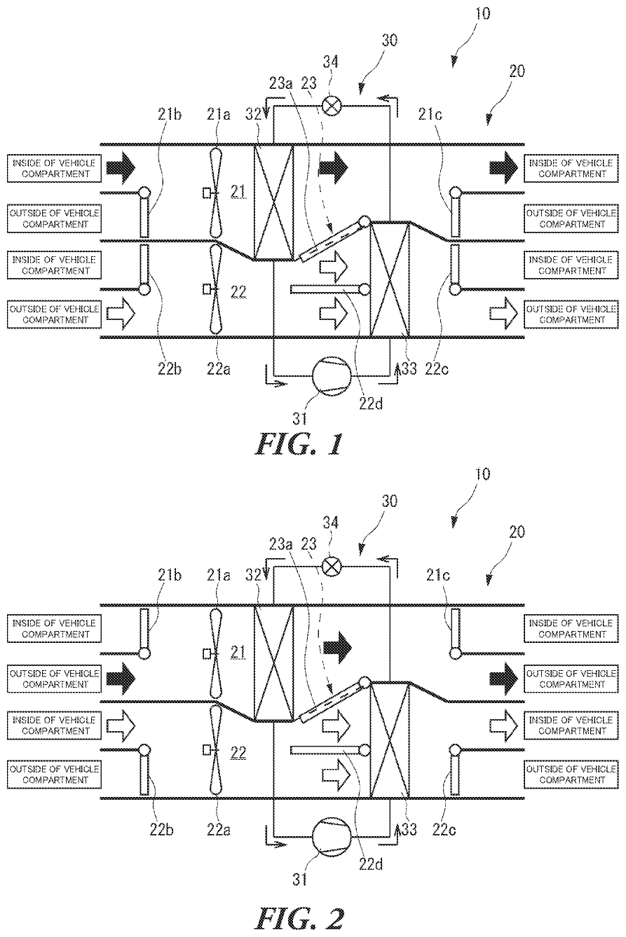

FIGS. 1 to 4 illustrate an embodiment of the invention.

The vehicle air conditioning apparatus according to the invention is configured to allow the air with adjusted temperature and humidity to blow to a passenger sitting on each of a plurality of seats for passengers disposed in the vehicle compartment.

This vehicle air conditioning apparatus includes an air conditioning unit 10 provided in each of the plurality of seats disposed in the vehicle compartment. The air conditioning unit 10 is disposed, for example, in the lower part of a seat, the ceiling of the vehicle compartment, the door trim, and the lower part of an armrest in the central part of the vehicle compartment in the width direction. The air supplied from the air conditioning unit to the vehicle compartment blows from outlets provided in the backrest and the surface of the seat, the lower part of the seat, the ceiling of the vehicle compartment, and a B-pillar of the vehicle.

As illustrated in FIG. 1, the air conditioning unit 10 includes a unit body 20, and a refrigerant circuit 30 provided in the unit body 20.

A first ventilation flue 21 and a second ventilation flue 22 extending in parallel with one another are formed in the unit body 20. One end and the other end of each of the first ventilation flue 21 and the second ventilation flue 22 communicate with the inside and the outside of the vehicle compartment. The middle part of the first ventilation flue 21 and the middle part of the second ventilation flue 22 communicate with one another via a communication path 23. A heat absorbing unit 32 described below, which is connected to the refrigerant circuit 30, is disposed in the first ventilation flue 21 in one end side of the communication path 23. Meanwhile, a heat releasing unit 33 described below, which is connected to the refrigerant circuit 30, is disposed in the second ventilation flue 22 in the other end side of the communication path 23.

The heat absorbing unit 32 and the heat releasing unit 33 are disposed in different positions in a direction in which the first ventilation flue 21 and the second ventilation flue extend. In addition, the heat absorbing unit 32 and the heat releasing unit 33 are disposed such that part of the heat absorbing unit 32 and part of the releasing unit 33 in a direction orthogonal to the direction in which the first ventilation flue 21 and the second ventilation flue 22 extend overlap with one another in the direction in which the first ventilation flue 21 and the second ventilation flue 22 extend.

A first blower 21a is provided in the one end side of the first ventilation flue 21 to allow the air to flow from the one end to the other end of the first ventilation flue 21. A first inflow damper 21b is provided upstream of the first blower 21a in the air flow direction in the one end side of the first ventilation flue 21. The first inflow damper 21b is configured to switch between one and both of the inside and the outside of the vehicle compartment with which the one end of the first ventilation flue 21 communicates. A first outflow damper 21c is provided in the other end side of the first ventilation flue 21. The first outflow damper 21c is configured to switch between one and both of the inside and the inside of the vehicle compartment with which the other end of the first ventilation flue 21 communicates.

A second blower 22a is provided in the one end side of the second ventilation flue 22 to allow the air to flow from the one end to the other end of the second ventilation flue 22. A second inflow damper 22b is provided upstream of the second blower 22a in the air flow direction in the one end side of the second ventilation flue 22. The second inflow damper 22b is configured to switch between one and both of the inside and the outside of the vehicle compartment with which the one end of the second ventilation flue 22 communicates. A second outflow damper 22c, as a downstream partition member (second ventilation flue partition), is provided in the other end side of the second ventilation flue 22. The second outflow damper 22c is configured to switch between one and both of the inside and the outside of the vehicle compartment with which the other end of the second ventilation flue 22 communicates. The second outflow damper 22c separates part of the second ventilation flue 22 downstream of the heat releasing unit into a space on the first ventilation flue 21 side and the remaining space, while the second ventilation flue 22 communicates with both the inside and the outside of the vehicle compartment. In addition, a flow path partition damper 22d, as an upstream partition member (second ventilation flue partition), is provided in the second ventilation flue 22 to separate part of the second ventilation flue 22 upstream of the heat releasing unit in the air flow direction into the one end side of the second ventilation flue 22 and the communication path 23 side. The second ventilation flue 22 is separated by the flow path partition damper 22d and the second outflow damper 22c into a space extending from the one end to the other end of the second ventilation flue 22, and a space extending from the communication path 23 to the other end of the second ventilation flue 22. The space extending from the one end to the other end of the second ventilation flue 22 communicates with the outside of the vehicle compartment. Meanwhile, the space extending from the communication path 23 to the other end of the second ventilation flue 22 communicates with the inside of the vehicle compartment.

A communication path opening and closing damper 23a configured to open and close the communication path 23 is provided for the communication path 23. The communication path opening and closing damper 23a can adjust the flow rate of the air flowing from the first ventilation flue 21 to the second ventilation flue 22 by adjusting the degree of opening of the communication path opening and closing damper 23a. As the degree of opening of the communication path opening and closing damper 23a is increased, the open area ratio of the communication path 23 is increased, and the open area ratio of the downstream side of the first ventilation flue 21 in the air flow direction is decreased. That is, when the degree of opening of the communication path opening and closing damper 23a is 0%, the communication path 23 is closed, and the open area ratio of the downstream side of the first ventilation flue 21 in the air flow direction is maximized. Meanwhile, when the degree of opening of the communication path opening and closing damper 23a is 100%, the open area ratio of the communication path 23 is maximized, and the downstream side of the first ventilation flue 21 in the air flow direction is closed.

The refrigerant circuit 30 includes: a compressor 31 configured to compress a sucked refrigerant and discharge the refrigerant; the heat absorbing unit 32 configured to perform a heat exchange between the air flowing through the first ventilation flue 21 and the refrigerant; the heat releasing unit 33 configured to perform a heat exchange between the air flowing through the second ventilation flue 22 and the refrigerant; and an expansion valve 34.

To be more specific about the refrigerant circuit 30, the input side of the heat releasing unit 33 into which the refrigerant flows is connected to the delivery side of the compressor 31 from which the refrigerant is discharged. The input side of the heat absorbing unit 32 into which the refrigerant flows is connected to the output side of the heat releasing unit 33 from which the refrigerant is discharged, via the expansion valve 34. The suction side of the compressor 31 into which the refrigerant is sucked is connected to the output side of the heat absorbing unit 32 from which the refrigerant is discharged.

In the vehicle air conditioning apparatus configured as described above, the air conditioning unit 10 performs the cooling operation, the heating operation, the cooling and dehumidifying operation, and the heating and dehumidifying operation, based on the temperature and the humidity of the vehicle compartment detected by sensors, or based on the setting operation by a passenger. For each of the cooling operation, the heating operation, the cooling and dehumidifying operation, and the heating and dehumidifying operation, the first blower 21a, the second blower 22a, and the compressor 31 are actuated.

For each of the cooling operation, the heating operation, the cooling and dehumidifying operation, and the heating and dehumidifying operation, the refrigerant discharged from the compressor 31 flows in the order of the heat releasing unit 33, the expansion valve 34, and the heat absorbing unit 32, and is sucked into the compressor 31 in the refrigerant circuit 30.

By this means, the refrigerant circulating through the refrigerant circuit 30 is subjected to a heat exchange with the air flowing through the second ventilation flue 22 and therefore releases the heat in the heat releasing unit 33, and is subjected to a heat exchange with the air flowing through the first ventilation flue 21 and therefore absorbs the heat in the heat absorbing unit 32.

For the cooling operation, the first inflow damper 21b allows the one end of the first ventilation flue 21 to communicate with one or both of the inside and the outside of the vehicle compartment (here, FIG. 1 illustrates the communication with the inside of the vehicle compartment), and the first outflow damper 21c allows the other end of the first ventilation flue 21 to communicate with the inside of the vehicle compartment. Meanwhile, the second inflow damper 22b allows the one end of the second ventilation flue 22 to communicate with the outside of the vehicle compartment, and the second outflow damper 22c allows the other end of the second ventilation flue 22 to communicate with the outside of the vehicle compartment. In addition, the flow path partition damper 22d is disposed not to separate the second ventilation flue 22 into the one end side of the second ventilation flue 22 and the communication path 23 side. The communication path 23 is closed by the communication path opening and closing damper 23a.

By this means, the air flowing from one or both of the inside and the outside of the vehicle compartment into the one end of the first ventilation flue 21 is subjected to a heat exchange with the refrigerant and therefore cooled in the heat absorbing unit 32, and supplied from the other end of the first ventilation flue 21 into the vehicle compartment. Meanwhile, the air flowing from the outside of the vehicle compartment into the one end of the second ventilation flue 22 is subjected to a heat exchange with the refrigerant and therefore is heated in the heat releasing unit 33, and is discharged from the other end of the second ventilation flue 22 to the outside of the vehicle compartment. Here, when the air is supplied into the vehicle compartment, the temperature of the air blowing into the vehicle compartment is controlled at a target air-blowing temperature by controlling, for example, the number of rotations of the compressor 31, the number of rotations of the blowers 21a and 22a, and the degree of opening of the expansion value 34.

For the heating operation, the first inflow damper 21b allows the one end of the first ventilation flue 21 to communicate with the outside of the vehicle compartment, and the first outflow damper 21c allows the other end of the first ventilation flue 21 to communicate with the outside of the vehicle compartment. Meanwhile, the second inflow damper 22b allows the one end of the second ventilation flue 22 to communicate with one or both of the inside and the outside of the vehicle compartment (here, FIG. 2 illustrates the communication with the inside of the vehicle compartment), and the second outflow damper 22c allows the other end of the second ventilation flue 22 to communicate with the inside of the vehicle compartment. In addition, the flow path partition damper 22d is disposed not to separate the second ventilation flue 22 into the one end side of the second ventilation flue 22 and the communication path 23 side. The communication path 23 is closed by the communication path opening and closing damper 23a.

By this means, the air flowing from the outside of the vehicle compartment into the one end of the first ventilation flue 21 is subjected to a heat exchange with the refrigerant and therefore is cooled in the heat absorbing unit 32, and then is discharged from the other end of the first ventilation flue 21 to the outside of the vehicle compartment. Meanwhile, the air flowing from one or both of the inside and outside of the vehicle compartment into the one end of the second ventilation flue 22 is subjected to a heat exchange with the refrigerant and therefore heated in the heat releasing unit 33, and then is supplied from the other end of the second ventilation flue 22 into the vehicle compartment. Here, when the air is supplied into the vehicle compartment, the temperature of the air blowing into the vehicle compartment is controlled at a target air-blowing temperature by controlling, for example, the number of rotations of the compressor 31, the number of rotations of the blowers 21a and 22a, and the degree of opening of the expansion value 34.

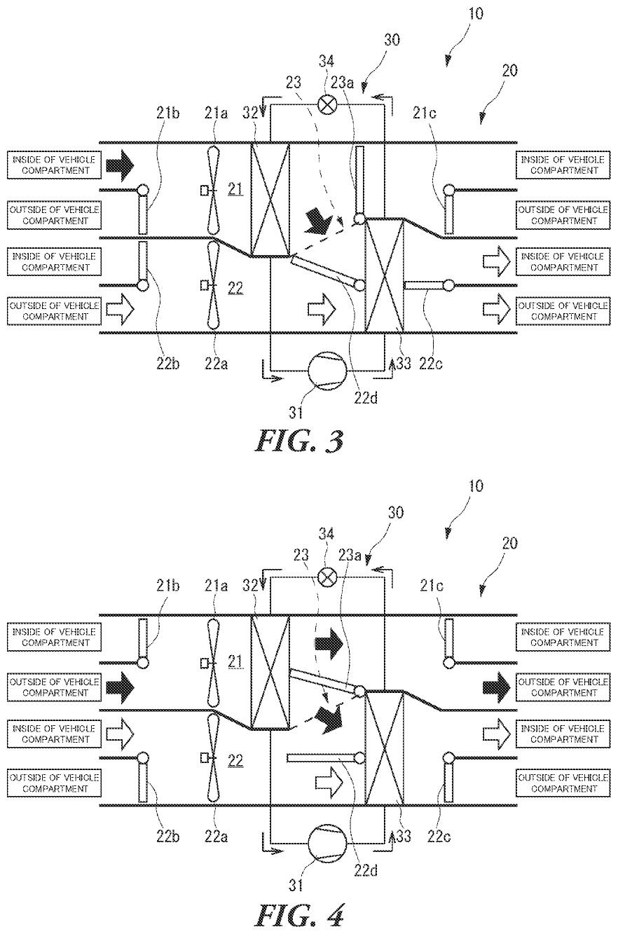

For the cooling and dehumidifying operation, the first inflow damper 21b allows the one end of the first ventilation flue 21 to communicate with one or both of the inside and the outside of the vehicle compartment (here, FIG. 3 illustrates the communication with the inside of the vehicle compartment), and the communication path opening and closing damper 23a closes the other end of the first ventilation flue 21. Meanwhile, the second inflow damper 22b allows the one end of the second ventilation flue 22 to communicate with the outside of the vehicle compartment, and the second outflow damper 22c allows the other end of the second ventilation flue 22 to communicate with the inside and the outside of the vehicle compartment. In addition, the flow path partition damper 22d is disposed to separate the second ventilation flue 22 into the one end side of the second ventilation flue 22 and the communication path 23 side. The communication path 23 is fully opened by the communication path opening and closing damper 23a.

By this means, the air flowing from one or both of the inside and the outside of the vehicle compartment into the one end of the first ventilation flue 21 is subjected to a heat exchange with the refrigerant and therefore is cooled in the heat absorbing unit 32 to reduce its moisture content, and then flows into the second ventilation flue 22 via the communication path 23. Meanwhile, the air flowing from the outside of the air into the one end of the second ventilation flue 22 is subjected to a heat exchange with the refrigerant and therefore is heated in the heat releasing unit 33, and then is discharged from the other end of the second ventilation flue 22 to the outside of the vehicle compartment. Moreover, the air flowing into the second ventilation flue 22 via the communication path 23 is heated in the heat releasing unit 33 and supplied from the other end of the second ventilation flue 22 into the vehicle compartment. The air supplied into the vehicle compartment is controlled at the target air-blowing temperature by the second outflow damper 22c, by adjusting the mixing ratio of the air flowing from the one end of the second ventilation flue 22 to the air flowing from the one end of the first ventilation flue 21 into the second ventilation flue 22.

For the heating and dehumidifying operation, the first inflow damper 21b allows the one end of the first ventilation flue 21 to communicate with the outside of the vehicle compartment, and the first outflow damper 21c allows the other end of the first ventilation flue 21 to communicate with the outside of the vehicle compartment. Meanwhile, the second inflow damper 22b allows the one end of the second ventilation flue 22 to communicate with one or both of the inside and the outside of the vehicle compartment (here, FIG. 4 illustrates the communication with the inside of the vehicle compartment), and the second outflow damper 22c allows the other end of the second ventilation flue 22 to communicate with the inside of the vehicle compartment. In addition, the flow path partition damper 22d is disposed not to separate the second ventilation flue 22 into the one end side of the second ventilation flue 22 and the communication path 23 side. The communication path 23 is open at a predetermined degree of opening by the communication path opening and closing damper 23a.

By this means, the air flowing from the outside of the vehicle compartment into the one end of the first ventilation flue 21 is subjected to a heat exchange with the refrigerant and therefore cooled in the heat absorbing unit 32 to reduce its moisture content, and part of the air is discharged from the other end of the first ventilation flue 21 to the outside of the vehicle compartment, and the remaining air flows into the second ventilation flue 22 via the communication path 23. Meanwhile, the air flowing from one or both of the inside and the outside of the vehicle compartment into the one end of the second ventilation flue 22 is subjected to a heat exchange with the refrigerant and therefore heated in the heat releasing unit 33, and then is supplied from the other end of the second ventilation flue 22 into the vehicle compartment. Moreover, the air flowing into the second ventilation flue 22 via the communication path 23 and cooled in the heat absorbing unit 32 to reduce its moisture content is heated in the heat releasing unit 33, and then supplied from the other end of the second ventilation flue 22 into the vehicle compartment. The air supplied into the vehicle compartment is controlled at the target air-blowing temperature by the flow path partition damper 22d, by adjusting the mixing ratio of the air flowing from the communication path 23 into the second ventilation flue 22 to the air flowing from the one end of the second ventilation flue 22.

As described above, in the vehicle air conditioning apparatus according to the present embodiment, the communication path 23 is formed to allow communication between the part of the first ventilation flue 21 downstream of the heat absorbing unit 32 in the air flow direction and the part of the second ventilation flue 22 upstream of the heat releasing unit 33 in the air flow direction, and the communication path 23 is opened and closed by the communication path opening and closing damper 23a.

By this means, it is possible to perform the dehumidifying operation by opening the communication path 23 without need of devices such as a dedicated outdoor heat exchanger, and a solenoid valve and a four-way valve to switch the refrigerant flow path in the refrigerant circuit 30. Therefore, it is possible to reduce the manufacturing cost and improve the comfort of the vehicle compartment.

In addition, the communication path opening and closing damper 23a can adjust the ratio of the air flowing from the first ventilation flue 21 into the second ventilation flue 22 via the communication path 23 to the air flowing through the first ventilation flue 21.

By this means, it is possible to adjust the dehumidification performance of the air conditioning unit 10, and therefore to exert a required dehumidification performance.

In addition, when the communication path opening and closing damper 23a is set to maximize the ratio of the air flowing from the first ventilation flue 21 into the second ventilation flue 22 via the communication path 23, the communication path opening and closing damper 23a closes the downstream side of the first ventilation flue 21.

By this means, it is possible to close the downstream side of the first ventilation flue 21 by the communication path opening and closing damper 23a without needing a dedicated member to close the downstream side of the first ventilation flue 21, separately. Therefore, it is possible to prevent an increase in the size of the apparatus and reduce the manufacturing cost.

In addition, the flow path partition damper 22d and the second outflow damper 22c are provided to separate the second ventilation flue 22 into the space which extends from the one end to the other end of the second ventilation flue 22 and communicates with the outside of the vehicle compartment, and the space which extends from the communication path 23 to the other end of the second ventilation flue 22 and communicates with the inside of the vehicle compartment.

By this means, the air flowing from the one end of the second ventilation flue 22 into the second ventilation flue 22 and the air flowing into the second ventilation flue 22 via the communication path 23 are not mixed, and can be flowed out of the second ventilation flue 22. Therefore, the heat to be discharged to the outside of the vehicle compartment can be surely released into the air to be discharged to the outside of the vehicle compartment during the cooling and dehumidifying operation.

Moreover, the second ventilation flue 22 is separated by the flow path partition damper 22d and the second outflow damper 22c. The flow path partition damper 22d separates the part of the second ventilation flue 22 upstream of the heat releasing unit 33 in the air flow direction into the one end side of the second ventilation flue 22 and the communication path 23 side. The second outflow damper 22c separates the part of the second ventilation flue 22 downstream of the heat releasing unit 33 in the air flow direction into a part leading to the outside of the vehicle compartment and a part leading to the inside of the vehicle compartment at the other end of the second ventilation flue 22.

By this means, the air to be supplied into the vehicle compartment after being heated, and the air to be discharged out of the vehicle compartment after the heat is released into the refrigerant can be subjected to a heat exchange with the refrigerant in the single heat releasing unit 33. Therefore, it is possible to prevent an increase in the size of the apparatus and reduce the manufacturing cost.

Moreover, the second outflow damper 22c can switch the state of the part of the second ventilation flue 22 downstream of the heat releasing unit 33 in the air flow direction among: the state to separate the part of the second ventilation flue 22 downstream of the heat releasing unit 33 in the air flow direction into the part leading to the outside of the vehicle compartment and the part leading to the inside of the vehicle compartment at the other end of the second ventilation flue 22; a state to allow the other end to communicate with the inside of the vehicle compartment but restrict the other end from communicating with the outside of the vehicle compartment; and the state to allow the other end to communicate with the outside of the vehicle compartment but restrict the other end from communicating with the inside of the vehicle compartment.

By this means, the second outflow damper 22c can switch among the three states of the downstream side of the second ventilation flue 22 in the air flow direction without using a dedicated member for each of the states, and therefore it is possible to prevent an increase in the size of the apparatus and reduce the manufacturing cost.

Furthermore, the heat absorbing unit 32 and the heat releasing unit 33 are disposed in the positions different from one another in the direction in which the first ventilation flue 21 and the second ventilation flue 22 extend. Part of the first ventilation flue 21 and part of the second ventilation flue 22 in the orthogonal to the direction in which the first ventilation flue 21 and the second ventilation flue 22 extend overlap with one another in the direction in which the first ventilation flue 21 and the second ventilation flue 22 extend.

By this means, it is possible to reduce the dimension in the direction in which the first ventilation flue 21 and the second ventilation flue 22 are arranged, and therefore to prevent an increase in the size of the unit body 20.

Here, with the above-described embodiment, the air conditioning unit 10 is provided for each of the plurality of seats disposed in the vehicle compartment. However, this is by no means limiting, but the temperature and the humidity of the vehicle compartment may be adjusted by one air conditioning unit.

In addition, with the above-described embodiment, the air conditioning unit 10 for each of the plurality of seats disposed in the vehicle compartment adjusts the temperature and the humidity around the passengers. However, this is by no means limiting. For example, the temperature and the humidity of the vehicle compartment may be adjusted by combination of a conventional air conditioning apparatus provided across part of the vehicle compartment in front of the instrument panel and the engine room, and the air conditioning unit according to the invention.

### REFERENCE SIGNS LIST

10 air conditioning unit, 20 unit body, 21 first ventilation flue, 22 second ventilation flue, 22c second outflow damper, 22d flow path partition damper, 23 communication path, 23a communication path opening and closing damper, 30 refrigerant circuit, 32 heat absorbing unit, 33 heat releasing unit

1. A vehicle air conditioning apparatus comprising:
a refrigerant circuit including a heat releasing unit configured to release heat from a refrigerant and a heat absorbing unit configured to absorb heat into the refrigerant; and
a unit body including a first ventilation flue in which the heat absorbing unit is disposed, and a second ventilation flue in which the heat releasing unit is disposed,
the vehicle air conditioning apparatus being capable of performing:
cooling operation to perform a heat exchange between air flowing into the first ventilation flue and the refrigerant in the heat absorbing unit and supply the air into a vehicle compartment, and to perform a heat exchange between air flowing into the second ventilation flue and the refrigerant in the heat releasing unit and discharge the air out of the vehicle compartment; and
heating operation to perform a heat exchange between the air flowing into the first ventilation flue and the refrigerant in the heat absorbing unit and discharge the air out of the vehicle compartment, and to perform a heat exchange between the air flowing into the second ventilation flue and the refrigerant in the heat releasing unit and supply the air into the vehicle compartment,
wherein the unit body includes a communication path configured to allow communication between part of the first ventilation flue downstream of the heat absorbing unit in an air flow direction and part of the second ventilation flue upstream of the heat releasing unit in the air flow direction, and
the communication path is opened and closed by a communication path opening and closing damper.

2. The vehicle air conditioning apparatus according to claim 1, wherein the communication path opening and closing damper can adjust a ratio of the air flowing from the first ventilation flue into the second ventilation flue via the communication path to the air flowing through the first ventilation flue.

3. The vehicle air conditioning apparatus according to claim 2, wherein when the communication path opening and closing damper is set to maximize the ratio of the air flowing from the first ventilation flue into the second ventilation flue via the communication path, the communication path opening and closing damper closes a downstream side of the first ventilation flue.

4. The vehicle air conditioning apparatus according to claim 1, further comprising a second ventilation flue partition configured to separate the second ventilation flue into a space which extends from an air inflow end to an air outflow end of the second ventilation flue and communicates with an outside of the vehicle compartment, and a space which extends from the communication path to the air outflow end and communicates with an inside of the vehicle compartment.

5. The vehicle air conditioning apparatus according to claim 4, wherein the second ventilation flue partition includes:
an upstream partition member configured to separate the part of the second ventilation flue upstream of the heat releasing unit in the air flow direction into the air inflow end side and the communication path side; and
a downstream partition member configured to separate part of the second ventilation flue downstream of the heat releasing unit in the air flow direction into a part leading to the outside of the vehicle compartment and a part leading to the inside of the vehicle compartment at the air outflow end.

6. The vehicle air conditioning apparatus according to claim 5, wherein the downstream partition member can switch a state of the part of the second ventilation flue downstream of the heat releasing unit in the air flow direction among: a state to separate the part of the second ventilation flue downstream of the heat releasing unit in the air flow direction into the part leading to the outside of the vehicle compartment and the part leading to the inside of the vehicle compartment at the air outflow end; a state to allow the air outflow end to communicate with the inside of the vehicle compartment but restrict the air outflow end from communicating with the outside of the vehicle compartment; and a state to allow the air outflow end to communicate with the outside of the vehicle compartment but restrict the air outflow end from communicating with the inside of the vehicle compartment.

7. The vehicle air conditioning apparatus according to claim 1, wherein:
the heat absorbing unit and the heat releasing unit are disposed in positions different from one another in a direction in which the first ventilation flue and the second ventilation flue extend; and
part of the heat absorbing unit and part of the heat releasing unit in a direction orthogonal to the direction in which the first ventilation flue and the second ventilation flue extend overlap with one another in the direction in which the first ventilation flue and the second ventilation flue extend.

8. The vehicle air conditioning apparatus according to claim 2, further comprising a second ventilation flue partition configured to separate the second ventilation flue into a space which extends from an air inflow end to an air outflow end of the second ventilation flue and communicates with an outside of the vehicle compartment, and a space which extends from the communication path to the air outflow end and communicates with an inside of the vehicle compartment.

9. The vehicle air conditioning apparatus according to claim 3, further comprising a second ventilation flue partition configured to separate the second ventilation flue into a space which extends from an air inflow end to an air outflow end of the second ventilation flue and communicates with an outside of the vehicle compartment, and a space which extends from the communication path to the air outflow end and communicates with an inside of the vehicle compartment.

10. The vehicle air conditioning apparatus according to claim 2, wherein:
the heat absorbing unit and the heat releasing unit are disposed in positions different from one another in a direction in which the first ventilation flue and the second ventilation flue extend; and
part of the heat absorbing unit and part of the heat releasing unit in a direction orthogonal to the direction in which the first ventilation flue and the second ventilation flue extend overlap with one another in the direction in which the first ventilation flue and the second ventilation flue extend.

11. The vehicle air conditioning apparatus according to claim 3, wherein:
the heat absorbing unit and the heat releasing unit are disposed in positions different from one another in a direction in which the first ventilation flue and the second ventilation flue extend; and
part of the heat absorbing unit and part of the heat releasing unit in a direction orthogonal to the direction in which the first ventilation flue and the second ventilation flue extend overlap with one another in the direction in which the first ventilation flue and the second ventilation flue extend.

12. The vehicle air conditioning apparatus according to claim 4, wherein:
the heat absorbing unit and the heat releasing unit are disposed in positions different from one another in a direction in which the first ventilation flue and the second ventilation flue extend; and
part of the heat absorbing unit and part of the heat releasing unit in a direction orthogonal to the direction in which the first ventilation flue and the second ventilation flue extend overlap with one another in the direction in which the first ventilation flue and the second ventilation flue extend.

13. The vehicle air conditioning apparatus according to claim 5, wherein:
the heat absorbing unit and the heat releasing unit are disposed in positions different from one another in a direction in which the first ventilation flue and the second ventilation flue extend; and
part of the heat absorbing unit and part of the heat releasing unit in a direction orthogonal to the direction in which the first ventilation flue and the second ventilation flue extend overlap with one another in the direction in which the first ventilation flue and the second ventilation flue extend.

14. The vehicle air conditioning apparatus according to claim 6, wherein:
the heat absorbing unit and the heat releasing unit are disposed in positions different from one another in a direction in which the first ventilation flue and the second ventilation flue extend; and
part of the heat absorbing unit and part of the heat releasing unit in a direction orthogonal to the direction in which the first ventilation flue and the second ventilation flue extend overlap with one another in the direction in which the first ventilation flue and the second ventilation flue extend.
